(19) United States
(12) Patent Application Publication
(10) Pub. No.: US 2005/0032946 A1
(43) Pub. Date: Feb. 10, 2005

(54) Resin composition

(75) Inventors: Roger Pierre-Elie Salvin, Saint Louis (FR); Alessandro Marchesini, Rosenau (FR); Masato Hoshino, Tokyo (JP)

Correspondence Address: PROSKAUER ROSE LLP;PATENT DEPARTMENT, 1585 BROADWAY, NEW YORK, NY, 10036-8299, US

(73) Assignee: Huntsman Advanced Materials Americas, Inc., Brewster, NY (US)

(21) Appl. No.: 10/498,032

(22) PCT Filed: Nov. 20, 2002
(86) PCT No.: PCT/EP02/12970

(30) Foreign Application Priority Data
Dec. 6, 2001 (CH) 2230/01

(51) Int. Cl. C08L 1/00

(52) U.S. Cl. 524/186; 524/556; 524/502

(57) ABSTRACT

The invention relates to a composition compriseing an at least bifunctional acidic prepolymer (A) curable under the action of heat an compound of the formula (I) in which A is a mono- to tetravalent, saturated or unsaturated alkyl group having 1 to 60 carbon atoms, a mono- to tetravalent aryl group, a mono- or diaiylamino group having 1 to 4 carbon atoms, an alkenylene group having 2 to 4 carbon atoms, a carboxyalkylene group or an alkoxycarbonylalkylene group having 1 to 4 carbon atoms, n is 1 or 2, m is 2-n, q is a number from 0 to 3, R¹ is hydrogen or an alkyl group having 1 to 5 carbon atoms or a hydroxyalkyl group having 1 to 5 carbon atoms and X is a radical of the formula in which R³ and R⁴ are identical or different and, independently of one another, are hydrogen, a straight-chain or branched alkyl group or hydroxyalkyl group having 1 to 5 carbon atoms, or R³ and R⁴, together with the carbon atom to which they are bonded, form a cycloaliphatic ring. The composition is suitable for the production of printed circuits.

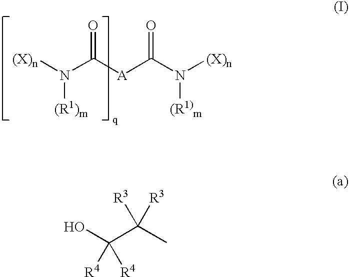

The invention relates to a resin composition and printed circuits compriseing an optionally photostructured layer produced from this resin composition.

In the production of printed circuits, a protective film is applied to a printed circuit board in order to protect the electrical circuit and to prevent adhesion of solder material in undesired areas when electrical parts are being soldered onto the printed circuit board. The great demand for increasingly light circuit boards and the wish for a high density of circuits mean that the compositions have to have very good adhesion properties, chemical stabilities and good electrical properties.

Conventional heat-curable and photopolymerizable compositions frequently comprise an epoxy compound and a photosensitive prepolymer. If such a composition is developed in an alkaline solution after drying and exposure, the unexposed parts of the photosensitive prepolymer are more poorly soluble owing to the presence of the epoxy compound. Moreover, the epoxy compound frequently reacts with the epoxide curing agent as early as during the drying step, which slows down the development and leads to a poorly developable layer on the copper surface.

U.S. Pat. No. 4,438,189 describes a composition compriseing a compound which comprises at least two terminal ethylenically unsaturated groups, a curing agent, a photocurable prepolymer and a compound which is heat-curable.

EP 0 323 563 describes a resin composition compriseing photosensitive prepolymer, a photoinitiator, a photopolymerizable vinyl monomer and/or a solvent and a finely pulverulent epoxy compound.

WO 94/03545 describes a composition as a coating material for metal and wood surfaces, compriseing a curing agent having a free carboxylic acid, a compound having a β-hydroxyalkylamido group and a polyester resin.

It has now surprisingly been found that outstanding curing and hence also excellent resistance to solvents can be achieved and crosslinking during drying can be substantially avoided if a thermally crosslinkable prepolymer compriseing acid groups is mixed with N-hydroxyalkyl-substituted carboxamides. Surprisingly, it was found that such a composition crosslinks extremely well at temperatures above 150° C. and thus forms layers which are resistant to solvents.

The invention relates to a composition having the features of claim 1. Further advantageous embodiments of the invention are evident from the dependent claims and the description.

The composition comprises a compound of the formula (I), 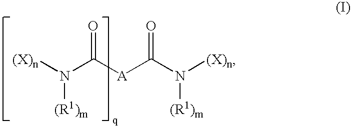
in which
A is a mono- to tetravalent, saturated, or unsaturated alkyl group having 1 to 60, preferably 1 to 20 and in particular 2 to 10 carbon atoms, such as, for example, ethyl, methyl, propyl, butyl, pentyl, hexyl, heptyl, octyl, nonyl, decyl, eicosyl, tricontyl, tetracontyl, pentacontyl or hexacontyl, a mono- to tetravalent aryl group, such as, for example, phenyl or naphthyl, a mono- or dialkylamino group having 1 to 4 carbon atoms, a mono- or di(hydroxyalkyl)amino group having 2 to 4 carbon atoms, such as, for example, dimethylamine, ethylamine or hydroxyethylamine, a mono- to tetravalent alkenyl group having 2 to 4 carbon atoms, such as, for example, ethenyl, 1-methylethenyl, 3-butene-1,3-diyl and 2-propene-1,2-diyl, carboxyalkyl or carboxyalkenyl groups, such as 3-carboxy-2-propenyl groups, alkoxycarbonylalkyl or alkoxycarbonylalkenyl groups having 1 to 4 carbon atoms, such as, for example, 3-methoxycarbonyl-2-propenyl groups,
R¹ is hydrogen, an alkyl group or a hydroxyalkyl group having 1 to 5 carbon atoms (such as, for example, methyl, ethyl, n-propyl, n-butyl, sec-butyl, tert-butyl or pentyl, 2-hydroxyethyl, 3-hydroxypropyl, 2-hydroxypropyl, 4-hydroxybutyl, 3-hydroxybutyl or 2-hydroxy-2-methylpropyl) and
n is 1 or 2, m is 2-n and q is a number from 0 to 3,
X is a radical of the formula 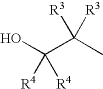
   in which R³ and R⁴ are identical or different and each radical, independently of one another, is hydrogen or straight-chain or branched alkyl having 1 to 5 carbon atoms or R³ and R⁴, together with the carbon atom to which they are bonded, form a cycloaliphatic ring (such as, for example, cyclopentyl or cyclohexyl), or are a hydroxyalkyl group having 1 to 5 carbon atoms (hydroxymethyl and 1-hydroxyethyl).

Particularly preferably, n is 2 and m is 0. A is preferably C₂-C₁₀-alkylene and particularly preferably C₂-C₈-alkylene, which may be linear or branched.

The composition according to the invention particularly preferably comprises a compound of the formula II, 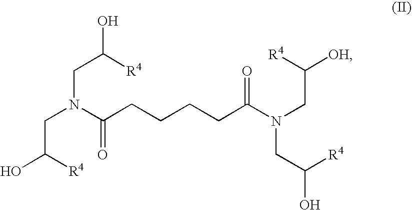
in which R⁴ is as defined above and is preferably hydrogen or methyl. These compounds are solid at 120° C. and become liquid at temperatures above 150° C.

In a further preferred embodiment, the compound of the formula I is a liquid bi- to tetrafunctional compound having a viscosity of 1 000-10 000 mPa·s at 25° C. Primid V 40-30 is particularly preferred.

The at least bifunctional acidic prepolymer (A) curable by the action of heat is preferably selected from the group consisting of the acrylate resins, polyurethane resins, the cyanate ester resins, the benzoxazine resins, the polyphenylene resins, the polyimide resins and mixtures thereof.

The composition according to the invention preferably comprises from 3 to 50% by weight, particularly preferably from 5 to 35% by weight and in particular from 8 to 20% by weight of the compounds of the formula I and from 97 to 50% by weight, particularly preferably from 95 to 65% by weight and in particular from 92 to 80% by weight, of a curable, at least bifunctional acidic prepolymer (A), based on the composition compriseing the two components.

In a particularly preferred embodiment, the composition according to the invention comprises an acidic prepolymer (A) which is both photocurable and heat-curable. This is preferably selected from the group consisting of:
a photocurable and heat-curable acidic prepolymer having an acid value of from 40 to 250 mg KOH/g, obtainable by reacting a polymer or copolymer compriseing unsaturated carboxyl groups with a compound which comprises an alicyclic epoxy group;
a photocurable and heat-curable acidic prepolymer, obtainable by complete esterification of the epoxy groups of an epoxy resin with an α,β-unsaturated carboxylic acid and subsequent reaction of the product thus obtained with a saturated or unsaturated carboxylic anhydride;
a photocurable and heat-curable acidic prepolymer, obtainable by reaction of a bisphenol A type epoxy compound with epichlorohydrin with formation of a post-glycidylated epoxy compound, subsequent complete esterification of the epoxy groups of the post-glycidylated epoxy compound with an α,β-unsaturated carboxylic acid and subsequent reaction of the product obtained with a saturated or unsaturated carboxylic anhydride, and
a photocurable and heat-curable acidic prepolymer, obtainable by reaction of a bisphenol A type epoxy compound with epichlorohydrin with formation of a post-glycidylated epoxy compound, mixing of the post-glycidylated epoxy compound with a novolak epoxy compound, complete esterification of the mixture with an α,β-unsaturated carboxylic acid and subsequent reaction of the product thus obtained with a saturated or unsaturated carboxylic anhydride.

These photocurable and heat-curable acidic prepolymers (A) may be present alone or as mixtures in the composition according to the invention.

The abovementioned unsaturated monobasic acid copolymer resins are obtainable by copolymerizing an ethylenically unsaturated carboxylic acid, such as, for example, (meth)acrylic acid, 2-carboxyethyl (meth)acrylate, 2-carboxypropyl (meth)acrylate, maleic anhydride and the like, with at least one monomer selected from the group consisting of (meth)acrylic esters, such as methyl (meth)acrylate, ethyl (meth)acrylate, propyl (meth)acrylate, butyl (meth)acrylate, 2-ethylhexyl (meth)acrylate, stearyl (meth)acrylate, hydroxyethyl (meth)acrylate, hydroxypropyl (meth)acrylate and the like; vinylaromatic compounds, such as styrene, α-methylstyrene, vinyltoluene, p-chlorostyrene and the like; amide-like unsaturated compounds, such as (meth)acrylamide, diacetoneacrylamide, N-methylolacrylamide, N-butoxymethylacrylamide and the like; polyolefin compounds, butadiene, isoprene, chloroprene and the like; and other compounds, such as (meth)acrylonitrile, methyl isopropenyl ketone, vinyl acetate, Beoba monomer (product of Shell Chemical), vinyl propionate, vinyl pivalate and the like. The acid value of the unsaturated copolymer is preferably in the range from 30 to 260 mg KOH/g.

The unsaturated compound compriseing an alicyclic epoxy group is a compound having an unsaturated group capable of free radical polymerization and an alicyclic epoxy group in one molecule. This unsaturated compound compriseing an alicyclic epoxy group is obtainable by copolymerization of an unsaturated monomer as a main monomer component compriseing an alicyclic epoxy group with at least one above-described monomer of the unsaturated monobasic acid copolymer resins, such as a (meth)acrylic ester, vinylaromatic compounds and the like.

For the preparation of the radiation-curable and photocurable acidic prepolymer from an unsaturated resin compriseing an alicyclic epoxy group and an unsaturated compound compriseing an acid group, a solution of an unsaturated resin compriseing an alicyclic epoxy group in an inert organic solvent is reacted with the unsaturated compound compriseing the acid group for from 1 to 7 hours at a temperature of from 20 to 110° C.

The radiation-curable and photocurable acid-compriseing prepolymer thus obtained has from 0.2 to 4.0, preferably from 0.7 to 3.5, double bonds per 1 000 molecular weight units and an average molecular weight of from 1 000 to 100 000 g/mol, preferably from 3 000 to 20 000 g/mol.

The following general formula (III) shows a photocurable and heat-curable acidic prepolymer (A) 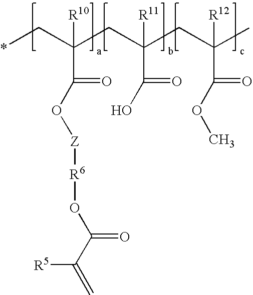
which is particularly preferably present in the composition according to the invention and in which
R⁵ is hydrogen or a methyl group,
R⁶ is a divalent aliphatic saturated hydrocarbon group having 1 to 14 carbon atoms and in particular a linear or branched alkylene chain, such as methylene, ethylene, propylene, tetramethylene, ethylethylene, pentamethylene or hexamethylene, or a phenylene,
R¹⁰, R¹¹ and R¹², independently of one another, are hydrogen or a methyl group,
Z is a direct bond or a divalent cycloalkane having 5 to 10 carbon atoms,
a and b are numbers from 1 to 10 and c is a number from 0 to 10.

In the resin composition according to the invention, the ratio a:b:c is preferably 5:3:2. The acid value is preferably in the range of 60-90 mg KOH/g, since the composition is most stable and has the best properties in this range. The molecular weight is preferably in the range from 400-6 000 g/mol.

For the preparation of an acidic prepolymer which is curable by the action of heat and photocurable from an acrylic resin compriseing an acid group and an unsaturated compound compriseing an alicyclic epoxy group, for example, a solution of an acrylic resin compriseing an acid group in an inert organic solvent, such as alcohol, ester, aromatic hydrocarbons and the like, can be reacted with the unsaturated compound compriseing the alicyclic epoxy group at a temperature of from 20 to 120° C. for from 1 to 5 hours.

The acidic prepolymer preferably comprises from 0.2 to 4.0, particularly preferably from 0.7 to 3.7, double bonds per 100 g/mol molecular weight. If the number of double bonds is in this range, good curing is achieved and the adhesive properties with respect to the substrate and the resistance to water are ideal.

The photocurable and heat-curable acidic prepolymers preferably have an average molecular weight from 1 000 to 100 000 g/mol, particularly preferably from 3 000 to 70 000 g/mol. With these molecular weights, the photocurable acid-compriseing prepolymer can be readily used owing to its viscosity.

The acid value of the photocurable and heat-curable acidic prepolymer is preferably up to 120 mg KOH/g, since the composition according to the invention then has good water resistance.

Alternatively, photocurable and heat-curable acidic prepolymer which is obtainable by reacting a vinyl resin compriseing an alicyclic epoxy group and an unsaturated compound compriseing an acid group may also be present in the composition according to the invention.

The abovementioned photocurable and heat-curable resins may be present alone or in combination in the composition according to the invention.

In a further preferred embodiment, the composition according to the invention comprises, as acidic prepolymer (A) which is both curable by the action of heat and radiation-curable, the prepolymer of the formula IV, which has been reacted with a dicarboxylic anhydride, for example phthalic anhydride, 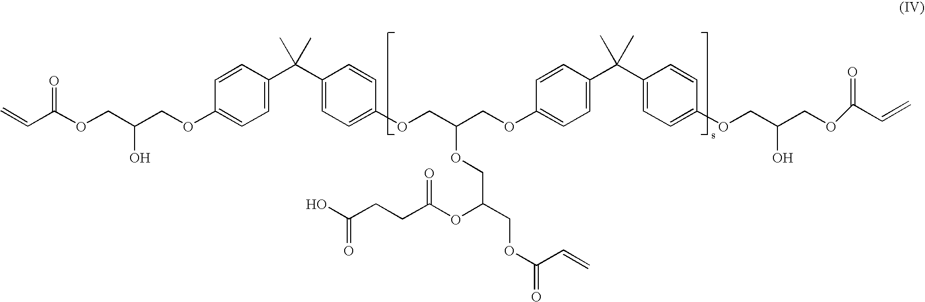
in which s is a number from 1 to 20.

The formulation according to the invention may also comprise a prepolymer (B) which is only photocurable.

The composition according to the invention has excellent photosensitivity. The compound of the formula I does not adversely influence the development process, and no gelling occurs. Consequently, the composition according to the invention can be rapidly developed. In the subsequent thermal step, the compound of the formula I is melted, unless it is already present in the liquid state, and is reacted with the photocurable and heat-curable acid-compriseing prepolymer. This gives a layer, such as, for example, a solder resist mask for circuit boards, which meets the abovementioned requirements.

In a further preferred embodiment, the formulation according to the invention additionally comprises a telechelic elastomer and/or a particulate material having a core and a shell, the core compriseing a silicone resin and the shell an acrylate resin. The telechelic elastomer has at least one primary hydroxyl group at one end of the molecule and has at least one epoxidized polyisoprene group at the other end of the molecule. A particularly preferred telechelic elastomer is the Kraton Liquid EKP-207 polymer. A particularly preferred particulate material having a core and a shell is Silicone Core Shell (Wacker AG, Germany). A layer produced using such a formulation is extremely resistant to rapid temperature changes.

A diluent, which is a photopolymerizable vinyl monomer and/or an organic solvent, is preferably added to the composition according to the invention.

The photopolymerizable vinyl monomers are preferably selected from the group consisting of hydroxyalkyl acrylates, such as 2-hydroxyethyl acrylate, 2-hydroxybutyl acrylate and the like; mono- or diacrylates of glycol, such as ethylene glycol, methoxytetraethylene glycol, polyethylene glycol, propylene glycol and the like, ethylene glycol diacrylate, diethylene glycol diacrylate and the like; acrylamides, such as N,N-dimethylacrylamide, N-methylolacrylamide, methylenebisacrylamide, diethylenetriaminetriacrylamide, bisacrylamidopropoxyethane, bismethacrylamidoethyl methacrylate, N-[(β-hydroxyethyloxy)ethyl]acrylamide and the like; aminoalkyl acrylates, such as N,N-dimethylaminoethyl acrylate and the like; polyvalent acrylates of polyols, such as hexanetriol, trimethylolpropane, pentaerythritol, dipentaerythritol, trihydroxyethyl isocyanurate and the like, and ethylene oxide adducts thereof or propylene oxide adducts; phenoxyacrylates, bisphenol A diacrylate and acrylates of ethylene oxide adducts and propylene oxide adducts of these phenols; acrylates of glycidyl ethers, such as glyceryl diglycidyl ether, trimethylolpropane triglycidyl ether, triglycidyl isocyanurate and the like; melamine acrylate; and methacrylates of the abovementioned acrylates; etc.

The organic solvents are preferably selected from the group consisting of the ketones, such as methyl ethyl ketone, cyclohexanone and the like; aromatic hydrocarbons, such as toluene, xylene, tetramethylbenzene and the like; glycol ethers, such as methylcellosolve, butylcellosolve, methylcarbitol, butylcarbitol, propylene glycol monomethyl ether, dipropylene glycol monoethyl ether, triethylene glycol monoethyl ether and the like; esters, such as ethyl acetate, butyl acetate, acetates of the abovementioned glycol ethers and the like; alcohols, such as ethanol, propanol, ethylene glycol, propylene glycol and the like; aliphatic hydrocarbons, such as octane, decane and the like; and petroleum solvents, such as petroleum ether, petroleum naphtha, hydrogenated petroleum naphtha, naphtha solvents and the like. These organic solvents serve for reducing the viscosity of the composition according to the invention, which leads to an improvement in its application properties.

The diluent may be used alone or as a mixture of a plurality of diluents. The composition according to the invention expediently comprises up to 15% by weight of the diluent, based on the composition according to the invention.

By adding the photopolymerizable vinyl monomer as a diluent, not only is the viscosity reduced but at the same time the photopolymerizabon rate is increased.

The photopolymerization initiator may also be added to the composition according to the invention if the composition is cured by UV exposure. Typical examples of photopolymerization initiators are benzoin and benzoin alkyl ethers, such as benzoin, benzil, benzoin methyl ether, benzoin ethyl ether, benzoin n-propyl ether, benzoin n-butyl ether, benzoin isopropyl ether and the like; benzophenones, such as benzophenone, p-methylbenzophenone, Michler's ketone, methylbenzophenone, 4,4′-dichlorobenzophenone, 4,4-bisdiethylaminobenzophenone and the like; acetophenones, such as acetophenone, 2,2-dimethoxy-2-phenylacetophenone, 2,2-diethoxy-2-phenylacetophenone, 1,1-dichloroacetophenone, 1-hydroxycyclohexyl phenyl ketone, 2-methyl[4-(methylthio)pheny]-2-morpholino-1-propanone, N,N-dimethylaminoacetophenone, and the like; thioxanthone and xanthones, such as 2,4 dimethylthioloxanthone, 2,4-diethylthioxanthone, 2-clhorothioxanthone, 2,4-diisopropylthioxanthone and the like; anthraquinones, such as anthraquinone, chloroanthraquinone, 2-methylanthraquinone, 2-ethylanthraquinone, 2-tert-butylanthraquinone, 1-chloroanthraquinone, 2-amylanthraquinone, 2-aminoanthraquinone and the like; ketals, such as acetophenone dimethyl ketal, benzyl dimethyl ketal and the like; benzoic esters, such as ethyl 4-dimethylaminobenzoate, 2-dimethylamino)ethyl benzoate, ethyl-dimethylaminobenzoate and the like; phenyl disulphides, 2-nitrofluorene, butyloin, anisoin ethyl ether, azobisisobutyronltriles, tetramethylthiuram disulphide and the like. These compounds may be present individually or in combination in the composition according to the invention.

The photopolymerization initiator is preferably present in an amount of from 0.1 to 10 percent by weight, based on the composition according to the invention.

The composition according to the invention may also comprise inorganic and/or organic fillers in order to improve the adhesion properties or the hardness of the layer. The inorganic fillers are preferably selected from the group consisting of barium sulphate, barium titanate, pulverized silica, finely pulverized silica, amorphous silica, talc, chalk, magnesium carbonate, calcium carbonate, alumina, aluminium hydroxide, mica powder and the like. The composition according to the invention comprises up to 40 percent by weight, preferably 5-30 percent by weight, of inorganic fillers, based on the composition according to the invention.

The composition according to the invention may also comprise additives, such as colorants, thickeners, antifoams, levelling agents, thermal polymerizabon inhibitors or antioxidants. Possible colorants are phthalocyanine blue, phthalocyanine green, iodine green, disazo yellow, crystal violet, titanium oxide, carbon black, naphthalene black and the like. Possible thermal polymerization inhibitors are hydroquinone, hydroquinone monomethyl ether, tert-butylcatechol, pyrogallol, phenothiazine and the like. Suitable thickeners are, for example, orbene, bentone, montmorillonite and the like. Suitable antifoams are, for example, fluorosilicone-like, fluoride-like or polymer-like antifoams.

In the production of a circuit board compriseing a layer, such as, for example, a solder resist mask, the printed circuit board is first coated with the composition according to the invention and then dried for evaporation of the diluent with formation of a layer (from 60 to 90° C. for from 15 to 60 minutes). This layer is then selectively exposed, preferably with the use of a patterned negative mask. After the exposure, the layer is developed with a developing liquid in order to remove the unexposed parts of the layer. Finally, the layer is postcured by heating, a solder resist mask serving as protective layer being obtained on the circuit board. The heat treatment for the postcuring can be carried out at from 100 to 160° C., preferably from 130 to 180° C.

Electronic components compriseing a layer produced using the formulation according to the invention are stable for a long time. One-layer or multilayer circuit boards compriseing at least one layer produced using the composition according to the invention are particularly preferred.

The formulation according to the invention is preferably sold in a set compriseing two compriseers A and B. Those components which react together are separated, so that the compriseer A comprises the compound of the formula I and the compriseer B comprises the remaining components, such as the acid-compriseing prepolymer curable under the action of heat and optionally the photocurable acid-compriseing prepolymer, the photopolymerization initiator and/or fillers.

The following examples explain the invention in more detail. Parts are parts by weight.

### EXAMPLE 1

### A Photocurable Acid-Compriseing Prepolymer

A mixture consisting of 20 parts of methyl methacrylate, 20 parts of styrene, 25 parts of methyl acrylate, 15 parts of 2-hydroxyethyl methacrylate, 20 parts of acrylic acid and 5 parts of azobisisobutyronitrile is added dropwise to 60 parts of butylcellosolve, which is initially introduced into a reactor, in a nitrogen atmosphere over a period of 3 hours. After the addition, the resulting mixture reacts for a further hour. Thereafter, a mixture consisting of 1 part of azobisdimethylvaleronitrile and 7 parts of butylcellosolve is added over a period of one hour and the resulting mixture in turn is reacted for 5 hours. The resin thus formed has a high acid value (150). After addition of 25 parts of an unsaturated resin having an alicyclid epoxy group and 0.06 part of hydroquinone, the resulting mixture is reacted at 80° C. for 5 hours with addition of air. The photocurable prepolymer thus obtained has an acid value of 60 and an average molecular weight of 10 000 g/mol.

### EXAMPLE 2

The glycidation of a side chain of an epoxy resin can be carried out by known methods as described, for example, in JP-A-8-134390. 100 parts of a bisphenol A type epoxy resin (GT7004, produced by Vantico; softening point 101° C., epoxide equivalent =730, average molecular weight 1 460, n=3.9 on average) are dissolved in a mixture of 171 parts of epichlorohydrin and 116 parts of dimethyl sulphoxide. 15 parts of 98.5% NaOH are added dropwise at 70° C. to this solution over a period of 100 minutes. After the addition, the reaction is carried out in a period of 3 hours at 70° C. The main part of the excess unreacted epichlorohydrin and of the dimethyl sulphoxide is then distilled off under reduced pressure. The reaction product contaminated with dimethyl sulphoxide and the salt formed as a byproduct are dissolved in 187.5 parts of methyl isobutyl ketone. 1.8 parts of 30% NaOH are added to this solution and reaction is effected at 70° C. for 1 hour. After the reaction, the reaction mixture is washed with 50 parts of water. After the organic phase has been separated from the aqueous phase, the isobutyl ketone is distilled off from the organic phase in order to obtain 81.2 parts of an epoxy resin having an epoxide equivalent of 305 and a softening point of 83° C. In the epoxy resin, 3.5 mol out of 3.9 mol of the alcoholic OH groups have been epoxidized.

### EXAMPLE 3

In a three-necked flask having a stirrer and a condenser, 1.09 parts of a cresol novolak type epoxy resin having an epoxide equivalent of 215 (JDCN-702, produced by Tohto Kasei AG) are heated and are melted at 90-100° C. while stirring. 390 parts of acrylic acid, 1 part of hydroquinone and 2 parts of benzyldimethylamine are then added. The mixture is heated to 110-115° C. and reacted for 12 hours while stirring. The solution thus obtained is then cooled to room temperature. The resulting product of a novolak type epoxy compound in which the acrylic acid is completely esterified has an acid value of 3 mg KOH/g. 450 parts of this product are introduced, together with 125 parts of ethylcarbitol acetate and 125 parts of Solvesso #150, into a reactor and stirred at 70-80° C. so that a homogeneous solution forms. One hydroxyl equivalent of the resulting solution is then reacted with 0.5 mol of tetrahydrophthalic anhydride. A solution of the acid anhydride adduct having an acid value of 58 mg KOH/g is obtained.

The compositions are prepared according to the ratios shown in table 1. The numerical values are stated in % by weight. After an initial brief mixing of the ingredients, each formulation is kneaded twice in a three-roll mill. The size distribution of the particles in each formulation is measured using a grindometer (produced by Erichsen Co.). The particles thus obtained are smaller than 16 μm.

The total surface area of a circuit board is coated with the composition and dried in an air circulation oven at 80° C. for 20 minutes. After drying, the layer thus obtained is exposed to light, developed and finally cured by heat in order to obtain a solder resist pattern.

Resistance to Hot/Cold Cycles

Each formulation is exposed through a photomask to ultraviolet light at a wavelength of 365 nm and in a dose of 200-400 mJ/cm² (measured using an integral actinometer produced by Oak Selsakusho AG). The development is carried out with a weakly aqueous alkaline developing solution for 60 seconds under a spray pressure of 2 kg/cm². The developed test board is placed in an apparatus for temperature change. The temperature is changed alternately from −55° C. to 125° C., the temperature being maintained in each case for 15 minutes. The term cycle is used when the temperature change from −55° C. to 125° C. (or back) is complete. The formation of new tears is checked after 50 cycles. If a tear is found, the test is terminated.

Photosensitivity Test

Each test board is exposed to ultraviolet light at a wavelength of 365 nm and in a dose of 300 mJ/cm², 400 mJ/cm² and 450 mJ/cm² (measured using an integral actinometer (Oak Seisakosho AG)). After the development with a weakly alkaline aqueous solution for 60 seconds under a gentle spray pressure of 2 kg/cm², the state of the film thus formed is checked visually and assessed according to the following criteria:
Q: no change observable
R: slight change observable
S: slight change of surface observable
T: the film is tom off.
   Development Test

The test board is prepared by exposure of the coated test board through a photomask to ultraviolet light having a wavelength of 365 nm and in a dose of 200-400 mJ/cm² (measured using an integral actinometer (Oak Seisakosho AG)). In the comparative examples, exposure is effected using a dose of 200-750 mJ/cm². The development is carried out in a weakly alkaline aqueous solution under a spray pressure of 2 kg/cm² for a period of 20, 40 or 60 seconds. After the development, the removal of the unexposed layer is checked visually and assessed according to the following criteria:
Q: complete development was achieved
R: a thin layer of undeveloped material remains on the surface
S: undeveloped material is distributed over the entire test board
T: scarcely any development was achieved.
   Adhesion Test (According to DIN 53151)

The test board is exposed through a photomask to ultraviolet light at a wavelength of 365 nm and in a dose of 200400 mJ/cm² (measured using an integral actinometer (Oak Seisakosho AG)). In the comparative examples, exposure is effected at a dose of from 200 to 750 mJ/cm². The development is carried out with a weakly alkaline aqueous solution under a spray pressure of 2 kg/cm² for a period of 60 seconds. The developed test boards are postcured under various conditions. Each test board thus obtained is subjected to a crosshatch test and subjected to a peel test with a cellophane adhesive tape. The test boards are then checked visually and the result is assessed according to the following criteria:
Q: 100/100 no peeling observable
R: 100/100 slight peeling in the crosshatch lines
S: 50/100 to 90/100 moderate adhesion
T: 0/100 to 50/100 weak adhesion.
   Pencil Hardness Test

The same test board used in the adhesion test is subjected to a hardness test by the method of JISK5400 under a load of 1 kg.

Acid Resistance Test

The same test board which is used in the adhesion test is placed in a 10% (V/V) aqueous sulphuric acid solution at 20° C. for 30 minutes. The acid resistance is assessed on the basis of the peeling and of the adhesion:
Q: no change observable
R: slight change observable
S: considerable change observable
T: swelling of the film or falling off of the film as a result of swelling observable.
   Alkali Resistance Test

The test and the assessment are carried out analogously to the acid resistance test, except that the aqueous sulphuric acid solution is replaced by a 10% by weight aqueous NaOH solution.

Solvent Resistance

The test and the assessment are carried out analogously to the add resistance test, except that the aqueous sulphuric acid is replaced by acetone.

Metallization Stability Test (Ni/Au stability)

The plating solution used is Aotolonex Cl (plating solution produced by Cellex Corp. USA). The test board used is the same as that used in the adhesion test. This is metallized for 9 minutes at a liquid temperature of 30° C. and a current density of 1 A/dm², in order to apply gold in a thickness of 1.5 μm. The condition of the film is assessed under the same criteria as for the acid resistance test.

Solder Resistance Test

According to the test methods described in JISC6481, the test board used in the adhesion test is immersed for 10 seconds in a solder bath at 260° C. (once on one side and 3 times on the other side). The condition of the film is then checked according to the same criteria as in the acid resistance test.

Sensitivity

A film of a sample is exposed to ultraviolet light at a wavelength of 365 nm and in a dose of 200-400 mJ/cm² (measured using an integral actinometer (Oak Seisakosho AG)) and then developed in a weakly alkaline aqueous solution under a spray pressure of 2 kg/cm² for 60 seconds. After the development, the film is checked visually. The photomask used is a Step-Tablet, produced by Stoffer Co. In the case of the test boards thus obtained, the tack/dryness after drying, the photosensitivity, the developability (condition of the film after development), flexibility after final curing, cold/hot stability, adhesion, hardness of the film, acid resistance, alkali resistance, solvent resistance, metallization stability, solder heat resistance, flux resistance, insulation resistance, insulabon resistance under humid conditions, resolution, water absorption and sensitivity are assessed. The results are summarized in table 2. The test boards of the comparative examples are exposed at 750 mJ/cm² since the surface of the resist is damaged and the characteristic properties cannot be compared with those exposed at 300 mJ/cm².

Stability of the Formulation After Mixing

The ingredients of the composition are combined. After initial brief mixing of the ingredients, each formulation is kneaded twice in a three-roll mill. The formulation is stored at 40° C. The stability of the formulation is checked daily.

Stability After Coating

The formulation is applied as described above to the surface of a circuit board. The coated circuit board is not further processed directly but is stored and further processed later on.

TABLE 1
Formulations

| Example No. | 1 | 2 | 3 | 4 | 5 | 6 | 7 | 8 |
|---|---|---|---|---|---|---|---|---|
| Resin | 40.6 | | | 24.13 | | 44.04 | | |
| according | | | | | | | | |
| to example 1 | | | | | | | | |
| Resin | | 40.88 | | | 43.77 | | 44.26 | |
| according | | | | | | | | |
| to example 2 | | | | | | | | |
| Resin | | | 39.34 | 14.67 | | | | 39.78 |
| according | | | | | | | | |
| to example 3 | | | | | | | | |
| Irgacure ® | 6.83 | 6.84 | 6.90 | 7.02 | 6.18 | 6.22 | 6.25 | 8.93 |
| 907 | | | | | | | | |
| Quantacure ® | 0.97 | 0.97 | 0.39 | 0.39 | 1.05 | 1.06 | | 0.40 |
| ITX | | | | | | | | |
| Sartomer ® | | | 2.93 | 3.04 | | | | 2.96 |
| 351 | | | | | | | | |
| Sartomer ® | 9.95 | 10.03 | 8.16 | 8.46 | 7.15 | 6.44 | 10.85 | 8.25 |
| 399 | | | | | | | | |
| Barium | 24.38 | 23.12 | 25.62 | 25.26 | 24.97 | 33.36 | 25.26 | 25.89 |
| sulphate | | | | | | | | |
| Flowlen AC | 0.31 | 0.31 | — | — | 0.33 | 0.34 | 0.34 | |
| 303 | | | | | | | | |
| TSA | — | — | 2.02 | 1.99 | | | | |
| 750 S ® | | | | | | | | |
| Disperbyl ® | 0.08 | 0.08 | 0.07 | 0.07 | 0.09 | 0.09 | 0.09 | 0.09 |
| 170 | | | | | | | | |
| Phthalocyanine | 0.44 | 0.44 | 0.54 | 0.56 | 0.48 | 0.48 | 0.48 | 0.54 |
| green | | | | | | | | |
| Primid XL 552 | 6.81 | 6.04 | 5.39 | 6.06 | 6.47 | | | |
| Primid ® | | | | | | 5.90 | 5.42 | 4.35 |
| V 40-30 | | | | | | | | |
| Particulate | | | | | 5.02 | | | |
| material having | | | | | | | | |
| a core and | | | | | | | | |
| shell (silicone | | | | | | | | |
| core shell) | | | | | | | | |
| Kraton L 207 | | | | | 1.50 | | | |

TABLE 2
Comparison of the properties

| | Example No. | | | | | | | |
|---|---|---|---|---|---|---|---|---|
| | 1 | 2 | 3 | 4 | 5 | 6 | 7 | 8 |
| Developability | Q | Q | Q | Q | Q | Q | R | Q |
| Photosensitivity | Q | Q | Q | Q | Q | Q | Q | Q |
| Adhesion in | 0 | 0 | 0 | 0 | 0 | 4 | 0 | 4 |
| crosshatch test | | | | | | | | |
| Pencil hardness | 6H | 6H | 6H | 6H | 4H | 5H | 7H | 6H |
| Punching behaviour | moderate | moderate | good | moderate | good | poor | moderate | poor |
| Acid resistance | Q | Q | Q | Q | Q | Q | Q | Q |
| Alkali resistance | Q | Q | Q | Q | Q | T | S | S |
| Solvent resistance | R | R | R | R | R | S | S | S |
| Solder resistance | Q | Q | Q | Q | Q | Q | Q | Q |
| Ni/Au stability | R | Q | Q | R | Q | T | T | T |
| Resistance to | <50 | <50 | <50 | <50 | >700 | <50 | <50 | <50 |
| hot/cold cycles | cycles | cycles | cycles | cycles | cycles | cycles | cycles | cycles |
| −55° C./15 min | | | | | | | | |
| +165° C./15 min | | | | | | | | |
| Hold time after | >7d | >7d | >7d | >7d | >7d | >7d | >1d | >7d |
| coating | | | | | | | | |
| Stability at 40° C. | >12W | >12W | >12W | >12W | >12W | >12W | <1d | >12W |

1. A composition compriseing an at least bifunctional acidic prepolymer (A) curable under the action of heat, which additionally comprises a compound of the formula I 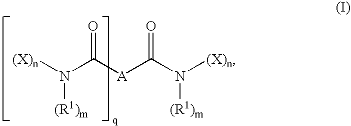
in which
A is a mono- to tetravalent, saturated or unsaturated alkyl group having 1 to 60 carbon atoms, a mono- to tetravalent aryl group, a mono- or dialkylamino group having 1 to 4 carbon atoms, an alkenylene group having 2 to 4 carbon atoms, a carboxyalkylene group or an alkoxycarbonylalkylene group having 1 to 4 carbon atoms in the alkylene group,
n is 1 or 2,
m is 2-n,
q is a number from 0 to 3,
R¹ is hydrogen or an alkyl group having 1 to 5 carbon atoms or a hydroxyalkyl group having 1 to 5 carbon atoms and
X is a radical of the formula 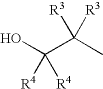
in which R³ and R⁴ are identical or different and, independently of one another, are hydrogen, a straight-chain or branched alkyl group or hydroxyalkyl group having 1 to 5 carbon atoms, or R³ and R⁴, together with the carbon atom to which they are bonded, form a cycloaliphatic ring.

2. A composition according to claim 1, compriseing, as the compound of the formula I, the compound of the formula II 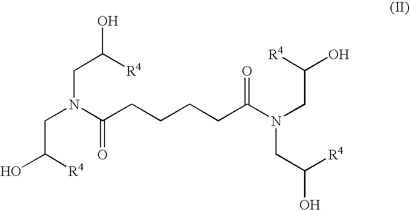
in which R⁴ in each case is hydrogen or in each case is a methyl group.

3. A composition according to claim 1, wherein the acidic prepolymer (A) is both heat-curable and photocurable.

4. A composition according to claim 1, which additionally comprises a photocurable prepolymer (B).

5. A composition according to claim 3 or claim 4, which additionally comprises a photopolymerization initiator.

6. A composition according to claim 1, which additionally comprises fillers.

7. A composition according to claim 2, wherein, in the compound of the formula II, R⁴ is in each case hydrogen.

8. A composition according to claim 2, wherein, in the compound of the formula II, R⁴ is in each case a methyl group.

9. A composition according to claim 1, wherein the acidic prepolymer (A) is a prepolymer of the formula III 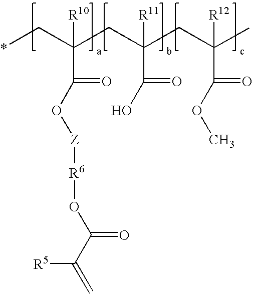
in which
R⁵ is hydrogen or a methyl group,
R⁶ is a linear or branched alkylene chain having 1 to 14 carbon atoms,
R¹⁰, R¹¹ and R¹², independently of one another, are hydrogen or a methyl group,
Z is a direct bond or cycloalkylene having 5 to 10 carbon atoms,
a and b are a number from 1 to 10 and c is a number from 0 to 10.

10. A composition according to claim 1, wherein the acidic prepolymer (A) is one which is obtainable by reacting a prepolymer of the formula IV with a dicarboxylic anhydride 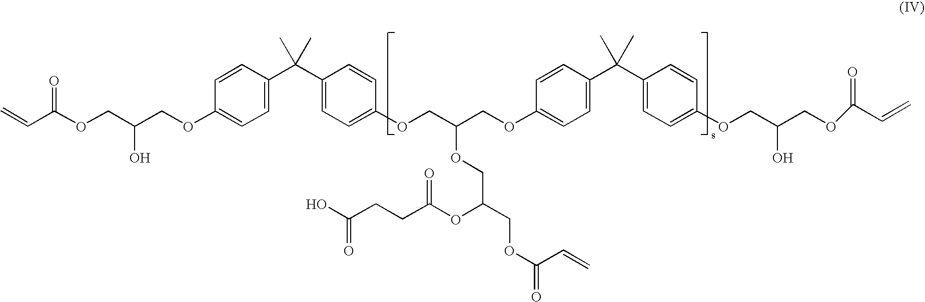
in which s is a number from 1 to 20 and
the acidic prepolymer (A) is curable both by the action of heat and by exposure to light.

11. A composition according to claim 1, which additionally comprises a telechelic elastomer and/or a particulate material having a core and a shell, the core compriseing a silicone resin and the shell an acrylate resin.

12. A printed circuit compriseing layer produced from the composition of claim 1.

13. A printed circuit according to claim 12, which is a circuit board.

14. A packaging unit compriseing two containers A and B, which together compromise the composition according to claim 1, wherein the container A comprises the compound of the formula I; and the container B comprises the at least bifunctional acidic prepolymer (A) curable under the action of heat and optionally one or more components selected from the group consisting of a photocurable prepolymer (B), a photopolymerization initiator, and fillers.

15. (canceled)

16. A process for the production of a circuit board compriseing the steps of forming a layer of the composition of claim 1 on the circuit board, and post-curing the layer.

17. The process of claim 16, further compriseing after formation of the layer, the step of drying the layer.

18. The process of claim 17, wherein the drying step is carried out at 60 to 90° C. and from 15 to 60 minutes.

19. The process of claim 16, further compriseing after the step of forming the layer, the steps of selectively exposing the layer and removing unexposed parts of the layer.

20. The process of claim 19, wherein the step of selectively exposing the layer is carried out with the use of a patterned negative mask.

21. The process of claim 19, wherein the step of removing unexposed parts of the layer is carried out by developing the layer with a developing liquid.

22. The process of claim 16, wherein the post-cure step is performed with heat treatment in the range from 100 to 160° C.

23. The process of claim 22, wherein the heat treatment is in the range from 130 to 180° C.
